(19) United States
(12) Patent Application Publication
(10) Pub. No.: US 2018/0283410 A1
(43) Pub. Date: Oct. 4, 2018

(54) FLUID PRESSURE CONTROL CIRCUIT AND FLUID PRESSURE CONTROL DEVICE

(71) Applicant: KYB Corporation, Tokyo (JP)

(72) Inventor: Akio MATSUURA, Kanagawa (JP)

(73) Assignee: KYB Corporation, Tokyo (JP)

(21) Appl. No.: 15/765,892

(22) PCT Filed: Sep. 8, 2016
(86) PCT No.: PCT/JP2016/076492

§ 371 Date: Apr. 4, 2018

(30) Foreign Application Priority Data
Oct. 16, 2015 (JP) 2015-204833

(51) Int. Cl. F15B 11/02

(52) U.S. Cl. CPC F15B 11/02; F15B 2211/3056; F15B 2211/251; F15B 2211/20576

(57) ABSTRACT

A fluid pressure control circuit connected to first and second pumps includes: a switching valve configured to allow for and disconnect a communication between the first and second pumps; and first and second unloading valves configured to unload working fluid discharged from the respective first and second pumps. The switching valve and the first and second unloading valves are disposed in separate valve sections.

### TECHNICAL FIELD

The present invention relates to a fluid pressure control circuit and a fluid pressure control device, comprising a plurality of circuit systems.

### BACKGROUND ART

A hydraulic control circuit (load sensing circuit) is conventionally known, as shown in JP2013-079552A, in which a pair of variable displacement pumps is connected to respective control valves for controlling respective actuators and in which an unloading valve is provided between these variable displacement pumps and control valves.

### SUMMARY OF INVENTION

When configuring the conventional hydraulic control circuit with valve blocks, providing various valves in one valve block would cause the valve block to increase in size. If a valve block of this type increases in size, loading or unloading of the valve block on or off a line would become difficult; accordingly, there was the problem of the difficulty in handling of the valve block, thus causing a drop in workability.

An object of the present invention is to provide a fluid pressure control circuit and a fluid pressure control device made to prevent an increase in the size of each of the valve blocks.

According to one aspect of the present invention, a fluid pressure control circuit is connected to a first pump and a second pump and is constituted by separate valve sections. The fluid pressure control circuit includes: a switching valve configured to allow for and disconnect a communication between the first pump and the second pump; a first unloading valve configured to unload working fluid discharged from the first pump; and a second unloading valve configured to unload working fluid discharged from the second pump. The switching valve, the first unloading valve and the second unloading valve are disposed respectively in the separate valve sections.

According to another aspect of the present invention, a fluid pressure control device has a plurality of valve blocks. The fluid pressure control device includes: a first valve block formed with a first pump port connected to a first pump and a second pump port connected to a second pump; a second valve block assembled with a first unloading valve configured to unload working fluid discharged from the first pump and a second unloading valve configured to unload working fluid discharged from the second pump; and a switching valve configured to allow for or disconnect a communication between the first pump and the second pump. The switching valve is assembled in the first valve block.

### BRIEF DESCRIPTION OF DRAWINGS

FIG. 1 is a circuit diagram showing a fluid pressure control device according to an embodiment of the present invention.

FIG. 2 is a plan view of a fluid pressure control device according to an embodiment of the present invention.

FIG. 3 is a circuit diagram of a fluid pressure control device according to a comparative example.

FIG. 4 is a plan view of a fluid pressure control device according to a comparative example.

### DESCRIPTION OF EMBODIMENTS

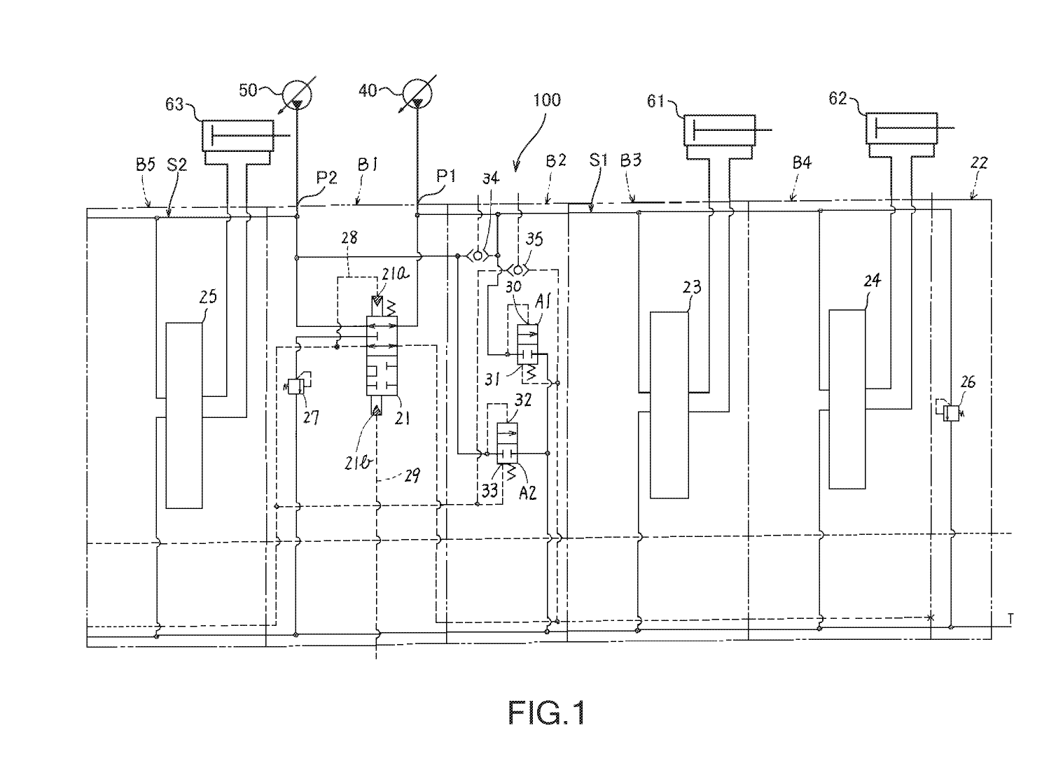

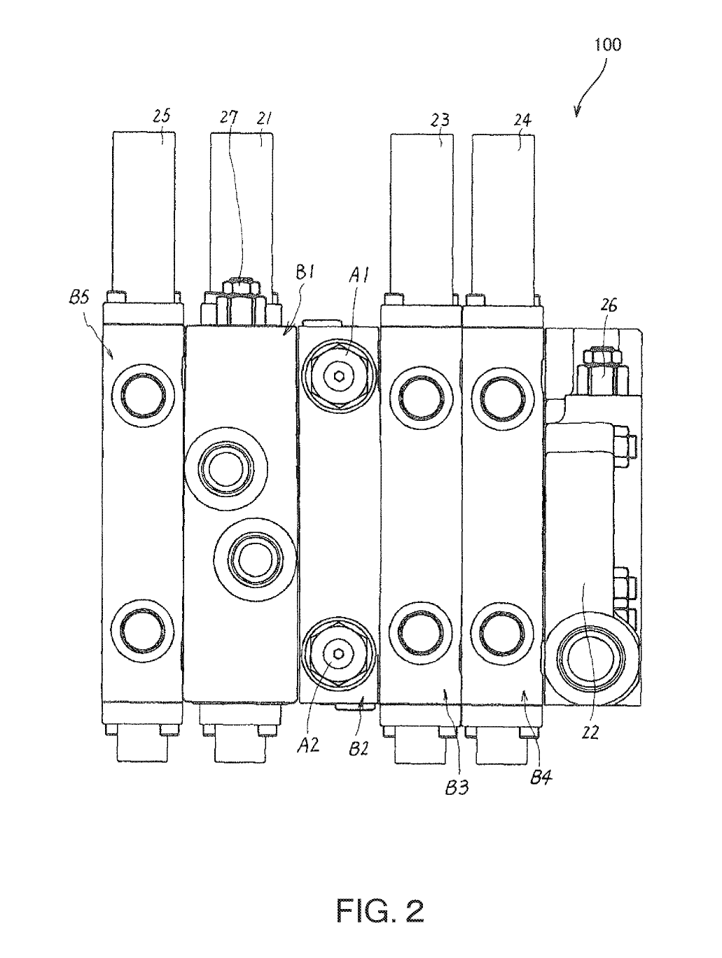

Described below with reference to the drawings is a fluid pressure control device 100 according to an embodiment of the present invention. FIG. 1 is a view showing a fluid pressure control circuit of the fluid pressure control device 100. FIG. 2 is a plan view of the fluid pressure control device 100. In the fluid pressure control device 100, oil or other aqueous alternative fluid and the like is used as working fluid.

As shown in FIG. 1 and FIG. 2, the fluid pressure control device 100 includes first to fifth valve blocks B1 to B5. The first valve block B1 is provided with a pair of first and second pump ports P1 and P2, and a pair of first and second pumps 40 and 50 of variable displacement types are connected to the respective first and second pump ports P1 and P2. Furthermore, a switching valve 21 is assembled into the first valve block B1. The first and the second pumps 40 and 50 communicate with each other or their communication is disconnected, in accordance with a switched position of the switching valve 21. In the fluid pressure control device 100 of the present embodiment, the first valve block B1 configures a valve section disposing the switching valve 21.

On one side of the first valve block B1 (right side in drawing), the second to fourth valve blocks B2 to B4 are connected in consecutive order. Furthermore, on an outer side of the fourth valve block B4 (opposite side to the third valve block B3), an outlet block 22 is connected, in which a tank port communicating with a tank T is formed. Moreover, on the other side of the first valve block B1 (left side in drawing), the fifth valve block B5 is connected. Although another valve block is connected on an outer side of the fifth valve block B5 (opposite side to the first valve block B1), this has been omitted in FIG. 1. In the fluid pressure control device 100 of the present embodiment, the third and fourth valve blocks B3 and B4 correspond to a first control valve block, and the fifth valve block B5 corresponds to a second control valve block.

As shown in FIG. 1, control valves 23 and 24 are assembled into the third and fourth valve blocks B3 and B4, respectively, each as a first control valve for controlling respective actuators 61 and 62 driven by working fluid discharged from the first pump 40. The actuators 61 and 62 are, for example, a reciprocal fluid pressure cylinder or a fluid pressure motor.

A first relief valve 26 communicating with the first pump port P1 is provided in the outlet block 22. Moreover, a second relief valve 27 is provided in the first valve block B1. The second relief valve 27 communicates with the second pump port P2 in accordance with a switched position of the switching valve 21. In a state in which a communication between the first and second pumps 40 and 50 is disconnected by the switching valve 21, the first relief valve 26 controls a maximum pressure of the first pump 40, and the second relief valve 27 controls a maximum pressure of the second pump 50.

Moreover, a control valve 25 is assembled into the fifth valve block B5 as a second control valve that communicates with the second pump port P2 and controls the actuator 63. Although not shown, another valve block is provided connected to the fifth valve block B5, and a control valve for controlling an actuator not shown is provided also in this valve block.

The fluid pressure control device 100 includes a first circuit system S1 provided on one side of the first valve block B1. The first circuit system S1 supplies working fluid supplied to the first pump port P1 to the actuators 61 and 62 via the control valves 23 and 24, and a second circuit system S2 provided on the other side of the first valve block B1. The second circuit system S2 supplies working fluid supplied to the second pump port P2 to the actuator 63 via the control valve 25.

The first valve block B1 is provided at a center between the first and second circuit systems S1 and S2. Accordingly, distances from the first and second pump ports P1 and P2 and the switching valve 21 to the first and second circuit systems S1 and S2 can be arranged at substantially equal lengths. In other words, the first valve block B1 is provided between the fifth valve block B5 assembled with the control valve 25 and the third and fourth valve blocks B3 and B4 assembled with the control valves 23 and 24, respectively. Accordingly, differences in distance from the first and second pump ports P1 and P2 and the switching valve 21 to the control valves 23 and 24 and the control valve 25 can be made small. That is to say, when the switching valve 21 is in a communicating state, it is possible to make a pressure loss of working fluid supplied from the first and second pumps 40 and 50 to the first and second circuit systems S1 and S2 (pressure loss of working fluid supplied from the first and second pumps 40 and 50 to the control valves 23 and 24 and the control valve 25) substantially equal.

The switching valve 21 provided in the first valve block B1 includes pilot chambers 21a and 21b. The pilot chamber 21a communicates with a load pressure introduction passage 28 into which maximum load pressures of the actuators 61, 62, and 63 in respective circuit systems are guided, and the other pilot chamber 21b communicates with a pilot passage 29. The pilot passage 29 receives pilot pressure in response to an operation by an operator.

The second valve block B2 is assembled with a pair of first and second unloading valves A1 and A2. The first unloading valve A1 is connected to the first pump port P1, and unloads working fluid discharged to the first pump port P1. The second unloading valve A2 is connected to the second pump port P2, and unloads working fluid discharged to the second pump port P2. In the fluid pressure control device 100 of the present embodiment, the second valve block B2 configures a valve section in which the first and second unloading valves A1 and A2 are disposed.

In the first unloading valve A1, pressure of the first pump port P1 is guided to the pilot chamber 30, and a maximum load pressure of the first circuit system S1 is guided to the other pilot chamber 31. Moreover, in the second unloading valve A2, pressure of the second pump port P2 is guided to the pilot chamber 32, and a maximum load pressure of the second circuit system S2 is guided to the other pilot chamber 33.

In the first and second unloading valves A1 and A2, when the switching valve 21 maintains the communicating state, identical pressure acts on the pilot chambers 30 and 32. Meanwhile, when the switching valve 21 is maintaining a disconnected state, a pressure of the first pump port P1 acts on the pilot chamber 30, while a pressure of the second pump port P2 acts on the pilot chamber 32.

Reference sign 34 in the drawing is a selector valve provided in the second valve block B2. The selector valve 34 selects a higher one of the pressures of the first and second pump ports P1 and P2, and guides the higher pressure to a regulator not shown of the first and second pumps 40 and 50. Moreover, reference sign 35 is a selector valve provided in the second valve block B2. The selector valve 35 guides a higher one of load pressures of the first and second circuit systems 51 and S2, to the regulator of the first and second pumps 40 and 50.

The fluid pressure control device 100, in accordance with the switched position of the switching valve 21, allows for merging and separation of the flows of the working fluid that are discharged from the first and second pumps 40 and 50 connected to the first and second pump ports P1 and P2, respectively. More specifically, the switching valve 21 can switch between the communicating state and the disconnected state of the first pump port P1 and the second pump port P2, due to an effect of the pilot pressure guided from the pilot passage 29, in response to an operation by the operator.

Moreover, as for the first and second unloading valves A1 and A2 assembled in the second valve block B2, when the switching valve 21 is in the communicating state, just one of either the first or second unloading valve A1 or A2 is necessary. However, when the switching valve 21 is in the disconnected state, the first and second unloading valves A1 and A2 need to be functioned separately. Therefore, in the fluid pressure control device 100 shown in FIG. 1, the two first and second unloading valves A1 and A2 are provided.

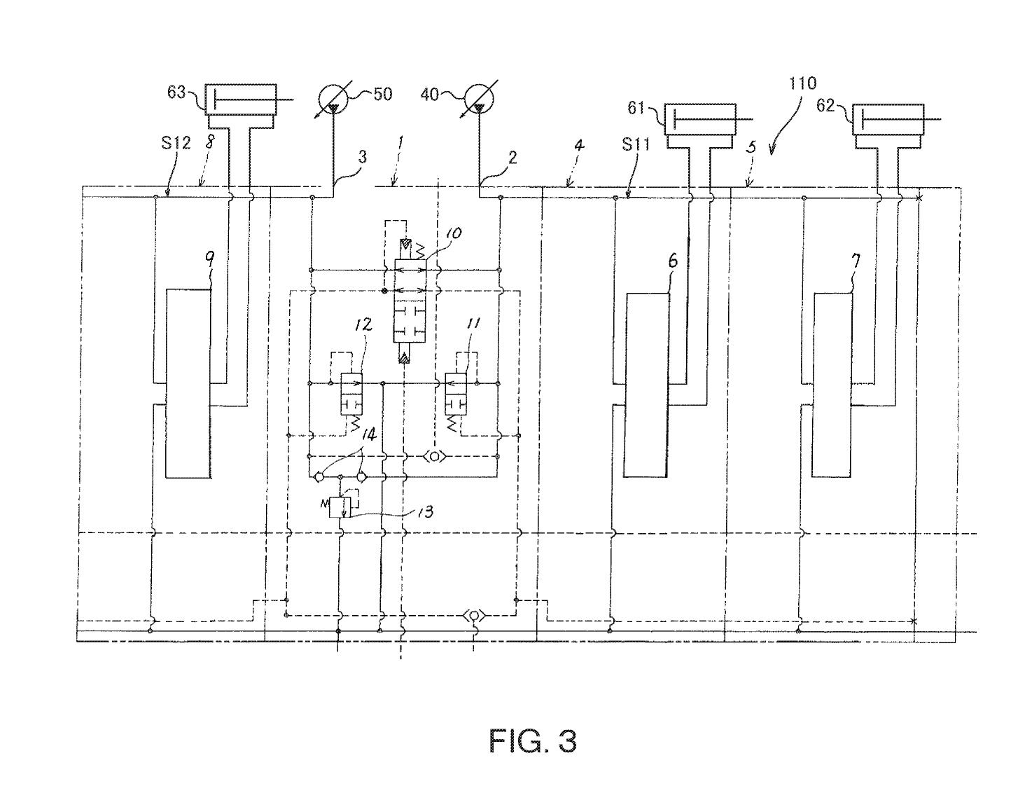

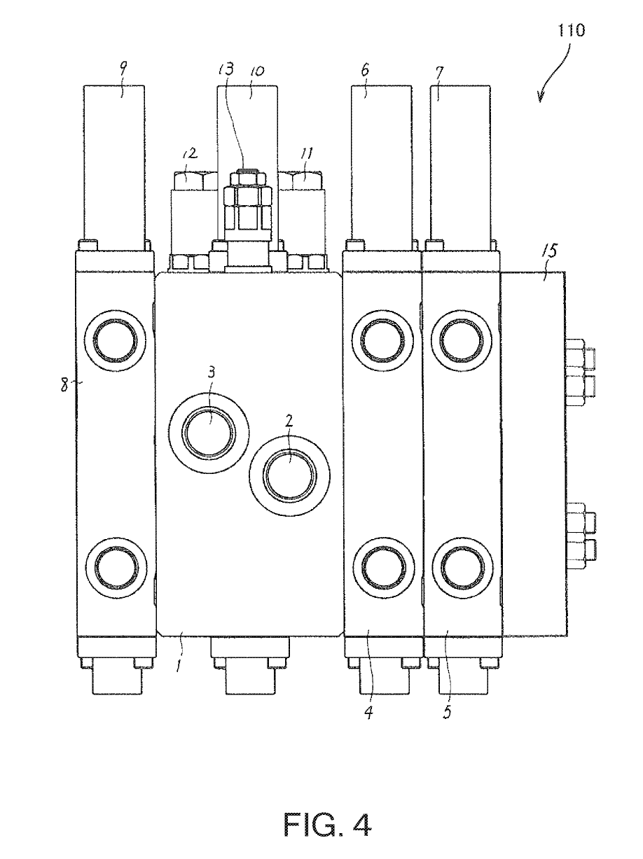

Here, a fluid pressure control device 110 shown in FIG. 3 and FIG. 4 as a comparative example is described.

As shown in FIG. 3 and FIG. 4, the fluid pressure control device 110 includes first to fourth valve blocks 1, 4, 5, and 8. A pair of first and second pump ports 2 and 3 is provided in the first valve block 1, and first and second pumps 40 and 50 of variable displacement types are connected to the first and second pump ports 2 and 3, respectively. Furthermore, the first valve block 1 is assembled with a switching valve 10. The first and second pumps 40 and 50 communicate with each other or their communication is disconnected, in accordance with a switched position of the switching valve 10. Furthermore, first and second unloading valves 11 and 12 and a relief valve 13 are provided in the first valve block 1. The first and second unloading valves 11 and 12 are provided in the first valve block 1, sandwiching the switching valve 10 therebetween.

On one side of the first valve block 1 (right side in drawing), the second and third valve blocks 4 and 5 are connected in consecutive order. Moreover, on the other side of the first valve block 1 (left side in drawing), the fourth valve block 8 is connected. Reference sign 15 in the drawing is an outlet block, and is provided on an outer side of the third valve block 5 (opposite side of the second valve block 4).

As shown in FIG. 3, the second and third valve blocks 4 and 5 are assembled with control valves 6 and 7, respectively, each communicating with the first pump port 2 and controlling respective actuators 61 and 62. Moreover, the fourth valve block 8 is assembled with a control valve 9 that communicates with the second pump port 3 and controls the actuator 63.

The fluid pressure control device 110 includes a first circuit system S11 provided on one side of the first valve block 1. The first circuit system S11 supplies working fluid supplied to the pump port 2 to the actuators 61 and 62 via the control valves 6 and 7, and a second circuit system S12 provided on the other side of the first valve block 1. The second circuit system S12 supplies working fluid supplied to the pump port 3 to the actuator 63 via the control valve 9.

In the fluid pressure control device 110, when the switching valve 10 is in the communicating state (when in the upper position in the drawing), discharged fluid from the first and second pumps 40 and 50 are merged and guided to the control valves 6, 7, and 9 in the first and second circuit systems S11 and S12. Meanwhile, when the switching valve 10 is in the disconnected state (when in the lower position in the drawing), the discharged fluid from the first and second pumps 40 and 50 is supplied separately to the respective first and second circuit systems S11 and S12.

The first and second unloading valves 11 and 12, when the switching valve 10 is in the communicating state, operates simultaneously by the same pressure, however when the switching valve 10 is in the disconnected state, the first and second unloading valves 11 and 12 operate separately by respective circuit pressures of the first and second circuit systems S11, S12.

The selector valve 14 selects a higher one of the pressures of the first and second circuit systems S1 1 and S12. The relief valve 13 controls a maximum pressure of the higher one of the pressures selected by the selector valve 14.

In the fluid pressure control device 110 configured as described above, the switching valve 10, the first and second unloading valves 11 and 12, the relief valve 13, and the selector valve 14 (see FIG. 3) are provided in a concentrated manner, as apparent also from FIG. 4. Therefore, the first valve block 1 is larger in size than the other valve blocks, namely, the second to fourth valve blocks 4, 5, and 8.

On this account, in the fluid pressure control device 100 of the present embodiment, the switching valve 21, the first unloading valve A1 and the second unloading valve A2 are disposed in separate valve sections. Therefore, as also apparent from FIG. 2, the size in the width direction of the first valve block B1 can be configured without largely differing from the second to fifth valve blocks B2 to B5. In the fluid pressure control device 100, the number of components increases by the amount of the second valve block B2, as compared to the fluid pressure control device 110 of the comparative example. However, in consideration of the assembling workability of the valve blocks, size reduction of each individual valve block would facilitate the handling of the valve blocks, and thus efficiency of the overall processes would improve.

In the present embodiment, the principle is that the working fluid discharged from the first and second pumps 40 and 50 is merged and is supplied to the actuators 61 to 63 of the first and second circuit systems S1 and S2. However, there may be cases depending on the actuators 61 to 63 of the first and second circuit systems S1 and S2, where the working fluid discharged from the first and second pumps 40 and 50 need to be supplied separately. Therefore, the fluid pressure control device 100 of the present embodiment is configured to communicate the first and second circuit systems S1 and S2, or disconnect this communication, by the switching valve 21.

Moreover, when the working fluid discharged from the first and second pumps 40 and 50 is merged, just one unloading valve or relief valve is enough. However, in the case in which the working fluid discharged from the first and second pumps 40 and 50 is supplied separately to the actuators 61 to 63 of the first and second circuit systems S1 and S2, the unloading valve and the relief valve are separately required. Accordingly, with a valve configuration of such a fluid pressure control circuit, the number of the valves unavoidably tend to increase.

However, in the fluid pressure control device 100 of the present embodiment, the first valve block B1 assembled with the switching valve 21 and the second valve block B2 assembled with the first and second unloading valves A1 and A2 are configured separately, and the first and second relief valves 26 and 27 are disposed separately in the outlet block 22 and the first valve block B1; hence, it is possible to avoid the increase in size of the valve block.

Moreover, in the fluid pressure control device 100, when the switching valve 21 is in the communicating state allowing for the communication between the first and second pumps 40 and 50, the second relief valve 27 is disconnected from the second circuit system S2 by the switching valve 21. Therefore, just the first relief valve 26 functions at this time. Meanwhile, when the switching valve 21 becomes in the disconnected state that disconnects the communication between the first and second pumps 40 and 50, the first relief valve 26 communicates just with the first circuit system S1, and the second relief valve 27 communicates just with the second circuit system S2. As such, in accordance with the switched position of the switching valve 21, the first relief valve 26 and the second relief valve 27 can be effectively functioned.

Description is made collectively for the configuration, functions, and effects of the embodiment of the present invention configured as described above.

The fluid pressure control circuit includes: a switching valve 21 that allows for and disconnects communication between first pump 40 and a second pump 50; and a first unloading valve A1 that unload working fluid discharged from the first pump 40, and a second unloading valve A2 that unload working fluid discharged from the second pump 50. The switching valve 21, the first unloading valve A1 and the second unloading valve A2 are respectively disposed in separate valve sections.

According to this configuration, since the switching valve 21, the first unloading valve A1 and the second unloading valve A2 are respectively disposed in the separate valve sections, there is no need to concentrate the switching valve 21, the first unloading valve A1 and the second unloading valve A2 into one valve block. Accordingly, it is possible to prevent a particular valve block from increasing in size.

Moreover, the fluid pressure control circuit includes a first pump port P1 connected to the first pump 40 and a second pump port P2 connected to the second pump 50. The first pump port P1 is connected to a first relief valve 26 that controls a maximum pressure of the first pump 40. The second pump port P2 is connected to a second relief valve 27 that controls a maximum pressure of the second pump 50. When the switching valve 21 is in a communicating state allowing for the first and second pumps 40 and 50 to communicate with each other, the first and second pumps 40 and 50 communicate with the first relief valve 26, and the first and second pumps 40 and 50 are disconnected from the second relief valve 27.

In this configuration, when the first and second pumps 40 and 50 communicate with each other, or also when the communication between the first and second pump 40 and 50 is disconnected, the first relief valve 26 and the second relief valve 27 can be effectively functioned in accordance with the switched position of the switching valve 21.

The fluid pressure control device 100 having a plurality of valve blocks includes: a first valve block B1 formed with a first pump port P1 connected to the first pump 40 and a second pump port P2 connected to the second pump 50; a second valve block B2 assembled with a first unloading valveA1 that unload working fluid discharged from the first pump 40 and a second unloading valve A2 that unload working fluid discharged from the second pump 50; and a switching valve 21 that allows for or disconnects a communication between the first pump 40 and the second pump 50. The switching valve 21 is assembled in the first valve block B1.

According to this configuration, since the switching valve 21 is assembled in the first valve block B1, and the first and second unloading valves A1 and A2 are assembled in the second valve block B2, there is no need to concentrate the switching valve 21 and the first and second unloading valve A1 and A2 into one valve block. Accordingly, it is possible to prevent the first valve block B1 and the second valve block B2 from increasing in size.

Moreover, the fluid pressure control device 100 further includes: a first control valve (control valves 23, 24) that controls first actuators 61 and 62 driven by working fluid discharged from the first pump 40; a second control valve (control valve 25) that controls a second actuator 63 driven by working fluid discharged from the second pump 50; a first control valve block (third and fourth valve blocks B3 and B4) assembled with the first control valve (control valves 23, 24); and a second valve block (fifth valve block B5) assembled with the second control valve (control valve 25). The first control valve block (third and fourth valve blocks B3, B4) is provided on one side of the first valve block B1, and the second control valve block (fifth valve block B5) is provided on the other side of the first valve block B1.

According to this configuration, differences in distance from the first and second pump ports P1 and P2 and the switching valve 21 to the control valves 23 and 24 and the control valve 25, can be made small. Namely, when the switching valve 21 is in the communicating state, it is possible to make a pressure loss of working fluid supplied from the first and second pumps 40 and 50 to the control valves 23 and 24 and the control valve 25 substantially equal.

Moreover, the fluid pressure control device 100 includes a first relief valve 26 that controls a maximum pressure of the first pump 40 and a second relief valve 27 that controls a maximum pressure of the second pump 50. When the switching valve 21 is in a communicating state that communicates the first and second pumps 40 and 50 with each other, the first and second pumps 40 and 50 communicate with the first relief valve 26, and communication between the first and second pumps 40 and 50 with the second relief valve 27 are disconnected.

In this configuration, when the first and second pumps 40 and 50 communicate with each other, or also when the communication between the first and second pump 40 and 50 is disconnected, the first relief valve 26 and the second relief valve 27 can be effectively functioned in accordance with the switched position of the switching valve 21.

Moreover, the fluid pressure control device 100 further includes an outlet block 22 formed with a tank port communicating with a tank T, and the first relief valve 26 is provided in the outlet block 22 and the second relief valve 27 is provided in the first valve block B1.

According to this configuration, since it is provided in the outlet block 22 of the first relief valve 26, it is possible to prevent the first valve block B1 from increasing in size by that amount.

Embodiments of this invention were described above, but the above embodiments are merely examples of applications of this invention, and the technical scope of this invention is not limited to the specific constitutions of the above embodiments.

Although a pair of pumps 40 and 50 of a variable displacement type is described as an example, this may be a fixed displacement type. Moreover, although a maximum load pressure is guided to the first and second unloading valves A1 and A2, these may be switched by other pressures.

This application claims priority based on Japanese Patent Application No. 2015-204833 filed with the Japan Patent Office on Oct. 16, 2015, the entire contents of which are incorporated into this specification.

1. A fluid pressure control circuit connected to a first pump and a second pump comprising:
a switching valve configured to allow for and disconnect a communication between the first pump and the second pump;
a first unloading valve configured to unload working fluid discharged from the first pump; and
a second unloading valve configured to unload working fluid discharged from the second pump, wherein
the switching valve, the first unloading valve and the second unloading valve are disposed respectively in the separate valve sections.

2. The fluid pressure control circuit according to claim 1, comprising:
a first pump port connected to the first pump, and a second pump port connected to the second pump, wherein
the first pump port is connected to a first relief valve configured to control a maximum pressure of the first pump,
the second pump port is connected to a second relief valve configured to control a maximum pressure of the second pump, and
when the switching valve is in a communicating state configured to communicate the first and second pumps, the first and second pumps communicate with the first relief valve, and the first and second pumps are disconnected from the second relief valve.

3. A fluid pressure control device having a plurality of valve blocks, the fluid pressure control device comprising:
a first valve block formed with a first pump port connected to a first pump and a second pump port connected to a second pump;
a second valve block assembled with a first unloading valve configured to unload working fluid discharged from the first pump and a second unloading valve configured to unload working fluid discharged from the second pump; and
a switching valve configured to allow for or disconnect a communication between the first pump and the second pump, wherein
the switching valve is assembled in the first valve block.

4. The fluid pressure control device according to claim 3, further comprising:
a first control valve configured to control a first actuator driven by working fluid discharged from the first pump;
a second control valve configured to control a second actuator driven by working fluid discharged from the second pump;
a first control valve block assembled with the first control valve; and
a second control valve block assembled with the second control valve, wherein
the first control valve block is provided on one side of the first valve block, and
the second control valve block is provided on another side of the first valve block.

5. The fluid pressure control device according to claim 3, further comprising:
a first relief valve configured to control a maximum pressure of the first pump; and
a second relief valve configured to control a maximum pressure of the second pump, wherein
when the switching valve is in a communicating state allowing for communicating the first pump with the second pump, the first and second pumps communicate with the first relief valve, and the first pump and the second pump are disconnected from the second relief valve.

6. The fluid pressure control device according to claim 5, further comprising:
an outlet block formed with a tank port communicating with a tank, wherein
the first relief valve is provided in the outlet block, and
the second relief valve is provided in the first valve block.
